(19) United States
(12) Patent Application Publication
(10) Pub. No.: US 2010/0030818 A1
(43) Pub. Date: Feb. 4, 2010

(54) SYSTEM AND METHOD FOR APPLYING ONCE A TRANSACTION DELIVERED IN A MESSAGE PUBLISHED ASYNCHRONOUSLY IN A DISTRIBUTED DATABASE

(75) Inventors: Brian Cooper, San Jose, CA (US); Hans-Arno Jacobsen, Toronto (CA); Adam Silberstein, San Jose, CA (US)

Correspondence Address: Law Office of Robert O. Bolan, P.O. Box 36, Bellevue, WA, 98009, US

(73) Assignee: YAHOO! INC., Sunnyvale, CA (US)

(21) Appl. No.: 12/184,200

(22) Filed: Jul. 31, 2008

(51) Int. Cl. G06F 17/30

(52) U.S. Cl. 707/201; 707/E17.005

(57) ABSTRACT

An improved system and method for applying once a transaction delivered in a message published asynchronously in a distributed database is provided. In various embodiments, apply once messaging may be achieved for asynchronous publication by having a persistent log stored on a messaging server. A messaging server may receive an update message for a transaction to be published asynchronously in a distributed database, may generate a sequence number for the transaction in a message, and may log the update message with the sequence number in a log file persistently stored on the messaging server. The messaging server may then send an acknowledgement that the update message is published and may asynchronously publish the update message with the sequence number to subscribers. The publication may only succeed if there may not be any message tagged with a sequence number that has been previously published by the messaging server.

### FIELD OF THE INVENTION

The invention relates generally to computer systems, and more particularly to an improved system and method for applying once a transaction delivered in a message published asynchronously in a distributed database.

### BACKGROUND OF THE INVENTION

In a distributed and replicated database, each data record may be replicated over several geographic regions, with one replica serving as the master data record that accepts updates and transmits them to the other replicas. Communication of updates between regions may be done through publishing messages to subscribers. The master region may publish record updates on an asynchronous channel to replicas that subscribe. Once an update is published to the messaging system, it will be delivered to all replicas. However, in some cases, it may be possible for the same update to be delivered multiple times to a replica, and this can cause problems.

Ideally, the publisher, such as a master replica, should only need to publish an update once. A failure may occur during the publish action, however, and it may not be possible to distinguish between the following two cases: (1) the publication failed, or (2) the publication succeeded but acknowledgement of the publication to the publisher was lost. In the first case, the message won't be delivered. But in the second case, the message will be delivered. However, the publisher cannot distinguish between the two cases. In order to ensure the message is delivered, publication may be repeated until an acknowledgement is received by the publisher. This is known as at least once publish. At least once publish assumes the update is idempotent, that is, the update is one that has no effect after the first application, and thus can be delivered any number of extra times. An example of an idempotent update is updating a user record to set a location field in the record to CA. Once the update is made, repeated application of the same update has no effect upon the user record.

Unfortunately, at least once is not sufficient for non-idempotent updates. Non-idempotent updates are updates where repeated application of the same update has an effect upon the record update, such as age=age+1 (age++). Clearly, each repeated delivery of this operation increases age. Such updates must be published exactly once. The message should be delivered once so that the age is incremented only once.

Furthermore, this same sort of problem may even occur for idempotent operations. Consider for example a publisher that first reads age=30, does an increment internally, and publishes a new age=31, which is then applied to the record. This mechanism uses an idempotent update by setting age=31. However, if this transaction fails and the publisher repeats it, the publisher will read age=31 and publish an update of age=32. In fact, the publisher does not want the update of age=32 to be applied, since the intention of the publisher is to add one to the original age of 30, resulting in a final age of 31.

What is needed is a mechanism to ensure certain transactions happen exactly once in an asynchronous message publishing system. Such a system and method should apply the update transaction exactly once, even if the transaction is repeated by having multiple publishes.

### SUMMARY OF THE INVENTION

The present invention provides a system and method for applying once a transaction delivered in a message published asynchronously in a distributed database. In an embodiment, a client computer may generate a sequence number for a transaction in a message to be published asynchronously in a distributed database. The client may log the message with the sequence number in a log file persistently stored on the client computer, and the client may send the update message with the sequence number to a messaging server for asynchronous publication in a distributed database. In the event the client does not receive an acknowledgement from the messaging server, the client may look up the update message with the sequence number in the log file persistently stored on the client, and the client may again send the update message with the sequence number to a messaging server for asynchronous publication.

In general, if a client repeats a message, or publishes a different message that still represents a repeated transaction, the message is published with the same unique sequence number. Thus, the publish may only succeed if there may not be any message tagged with a sequence number that has been previously published to the messaging machine. If the client re-attempts the publish with the first attempt having succeeded, for instance because the acknowledgement was lost, the subsequent publish attempt may fail. By having a persistent log stored on the client, apply once messaging may accordingly be achieved in an embodiment for asynchronous publication.

In various embodiments, apply once messaging may also be achieved for asynchronous publication by having a persistent log stored on a messaging server. A messaging server may receive an update message for a transaction to be published asynchronously in a distributed database, and the messaging server may generate a sequence number for a transaction in a message. The messaging server may send a failure response if a publish request has been already applied for the sequence number. Otherwise, the messaging server may log the update message with the sequence number in a log file persistently stored on the messaging server, and the messaging server may send an acknowledgement that the update message is published. Then the messaging server may asynchronously publish the update message with the sequence number to subscribers. In the event the messaging server does not receive an acknowledgement from the subscribers, the messaging server may look up the update message with the sequence number in the log file persistently stored on the messaging server and may again send the update message with the sequence number to subscribers for asynchronous publication.

In other embodiments, one of the subscribers for a message published asynchronously in a distributed database may be a view maintenance server responsible for listening to data updates and generating corresponding updates for data views. A view maintenance server may receive an update message with a sequence number from a messaging server publishing a transaction asynchronously in a distributed database. The view maintenance server may generate a view update message with the sequence number. The view maintenance server may obtain a message handle from a message handle free list, may then place the message handle on the message handle busy list, and may then add the message handle to the view update message with the sequence number. The view maintenance server may asynchronously publish the view update message with message handle and the sequence number to a message server. In the event that the view maintenance server does not receive an acknowledgement from the messaging server, the view maintenance server may again send the update message with the message handle and sequence number to a messaging server for asynchronous publication.

Lazy garbage collection may be performed to purge a sequence number and message handle from the log file of a messaging server when a message with a different sequence number re-uses a previously used handle. Once the publish attempt to a messaging server with a sequence number is acknowledged and the update of a data record with that sequence number is consumed by the subscribers so that it will not reappear for publication, even after a failure, the view maintenance server will move the handle from the message handle busy list back to the message handle free list. The view maintenance server may then re-use the message handle on another message sent to a messaging server for publication. When the messaging server receives a message tagged with the re-used message handle that occurs with some other sequence number, the messaging server may purge the sequences number tagged with the message handle logged in the log file persistently stored on the messaging server.

Thus, the present invention may provide a mechanism to ensure transactions happen exactly once in an asynchronous message publishing system. The system and method may apply the update transaction exactly once, even if the transaction is repeated by having multiple publishes. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for applying once a transaction delivered in a message published asynchronously in a distributed database, in accordance with an aspect of the present invention;

FIG. 3 is a flowchart generally representing the steps undertaken in one embodiment on a client for applying once a transaction delivered in a message published asynchronously in a distributed database, in accordance with an aspect of the present invention;

FIG. 4 is a flowchart generally representing the steps undertaken in one embodiment on a messaging server for applying once a transaction delivered in a message published asynchronously in a distributed database, in accordance with an aspect of the present invention;

FIG. 5 is a flowchart generally representing the steps undertaken in one embodiment on a messaging server for applying once an update message by generating a sequence number for asynchronously publication in a distributed database, in accordance with an aspect of the present invention;

FIG. 6 is a flowchart generally representing the steps undertaken in one embodiment on a view maintenance server for applying once a transaction delivered in a message published asynchronously in a distributed database, in accordance with an aspect of the present invention; and

FIG. 7 is a flowchart generally representing the steps undertaken in one embodiment on a messaging server for applying once an update message with a sequence number and a message handle from a view maintenance server delivered for asynchronously publication in a distributed database, in accordance with an aspect of the present invention.

### DETAILED DESCRIPTION

### Exemplary Operating Environment

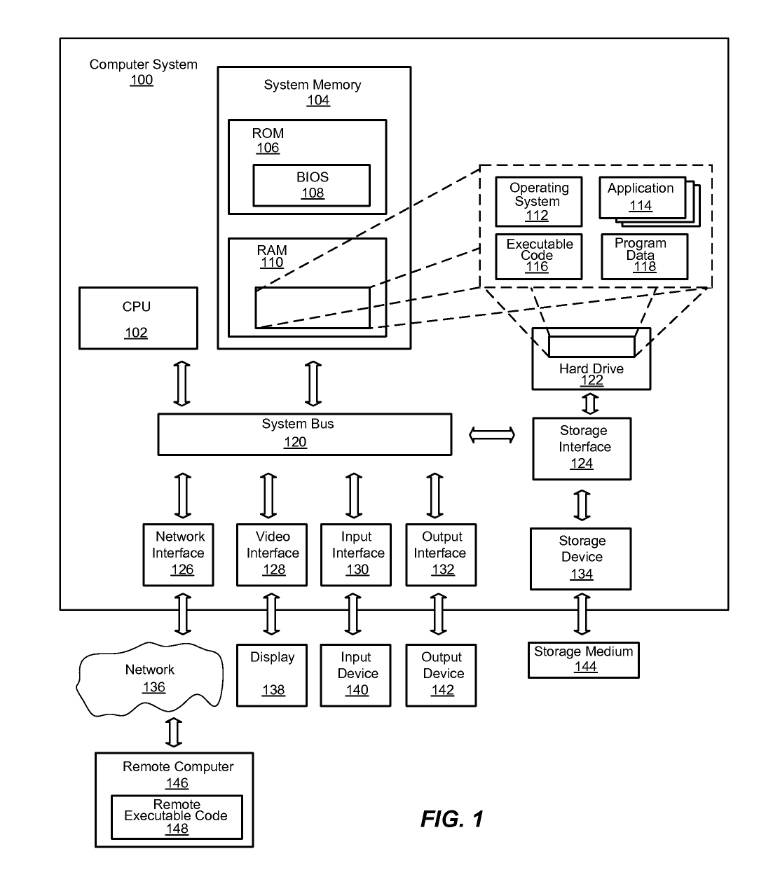

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Applying Once a Transaction Delivered in a Message Published Asynchronously in a Distributed Database

The present invention is generally directed towards a system and method for applying once a transaction delivered in a message published asynchronously in a distributed database. In an embodiment, apply once messaging may be achieved for asynchronous publication by having a persistent log stored on a client computer. A client computer may generate a sequence number for a transaction in a message to be published asynchronously in a distributed database. The client may log the message with the sequence number in a log file persistently stored on the client computer, and the client may send the update message with the sequence number to a messaging server for asynchronous publication in a distributed database. In the event the client does not receive an acknowledgement from the messaging server, the client may look up the update message with the sequence number in the log file persistently stored on the client, and the client may again send the update message with the sequence number to a messaging server for asynchronous publication.

In various embodiments, apply once messaging may also be achieved for asynchronous publication by having a persistent log stored on a messaging server. A messaging server may receive an update message for a transaction to be published asynchronously in a distributed database, may generate a sequence number for the transaction in a message, and may log the update message with the sequence number in a log file persistently stored on the messaging server. The messaging server may then send an acknowledgement that the update message is published and may asynchronously publish the update message with the sequence number to subscribers. The publication may only succeed if there may not be any message tagged with a sequence number that has been previously published by the messaging server.

As will be seen, lazy garbage collection may be performed to purge messages from the log file of a messaging server when a message with a different sequence number is assigned a previously used handle by a view maintenance server. As will be understood, the various block diagrams, flow charts and scenarios described herein are only examples, and there are many other scenarios to which the present invention will apply.

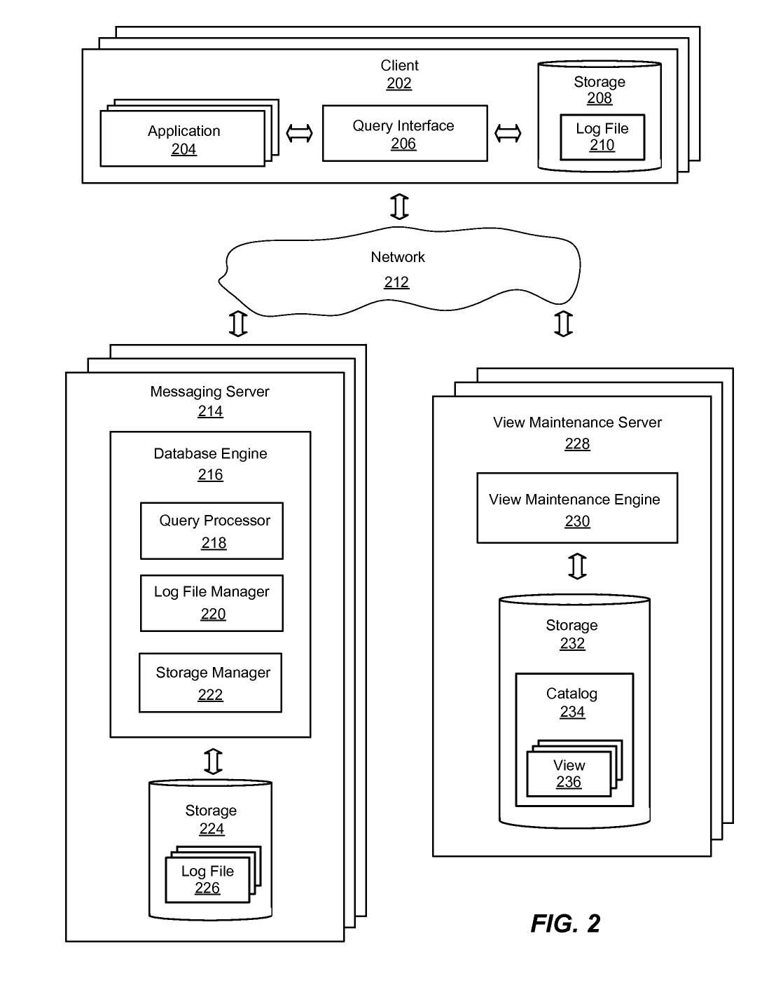

Turning to FIG. 2 of the drawings, there is shown a block diagram generally representing an exemplary architecture of system components for applying once a transaction delivered in a message published asynchronously in a distributed database. Those skilled in the art will appreciate that the functionality implemented within the blocks illustrated in the diagram may be implemented as separate components or the functionality of several or all of the blocks may be implemented within a single component. For example, the functionality for the storage manager 222 on the messaging server 214 may be implemented as a separate component from the database engine 216. Or the functionality for the storage manager 222 may be included in the same component as the database engine 216 as shown. Moreover, those skilled in the art will appreciate that the functionality implemented within the blocks illustrated in the diagram may be executed on a single computer or distributed across a plurality of computers for execution.

In various embodiments, several networked client computers 202 may be operably coupled to one or more messaging servers 214 and to one or more view maintenance servers 228 by a network 212. Each client computer 202 may be a computer such as computer system 100 of FIG. 1. The network 212 may be any type of network such as a local area network (LAN), a wide area network (WAN), or other type of network. An application 204 may execute on the client 202 and may include functionality for invoking a query interface 206 for sending a message to a messaging server 214 to publish a transaction to subscribers such as view maintenance servers 228 or other messaging servers 214. In general, the application 204 and the query interface 206 may be any type of interpreted or executable software code such as a kernel component, an application program, a script, a linked library, an object with methods, and so forth. The query interface may be operably coupled to storage 208 that stores a log file 210 of messages sent to a messaging server 214 for publication. The storage 208 may be any type of computer storage media.

The messaging servers 214 may be any type of computer system or computing device such as computer system 100 of FIG. 1. The messaging servers 214 may be part of a large distributed database system of operably coupled servers. In general, each messaging server 214 may provide services for asynchronously publishing messages that may include transactions for performing semantic operations on data in the distributed database system. A messaging server 214 may include a database engine 216 which may be responsible for communicating with a client 202, communicating with other messaging servers 214, and communicating with view maintenance servers 228. The database engine 216 may include query processor 218 for processing received queries, a log file manager 220 for logging messages to a log file 226 stored in storage 224, and a storage manager 222 for reading, writing and flushing messages in the log file 226. Each of these modules may also be any type of executable software code such as a kernel component, an application program, a linked library, an object with methods, or other type of executable software code. The storage 208 may be any type of computer storage media.

The view maintenance servers 228 may be any type of computer system or computing device such as computer system 100 of FIG. 1. The view maintenance servers 228 may be part of a large distributed database system of operably coupled servers. In general, each view maintenance server 228 may provide services for maintaining a number of views of the data in the distributed database. A view maintenance server 228 may include a view maintenance engine 230 which may be responsible for listening to data updates and generating corresponding updates for data views. Each of these modules may also be any type of executable software code such as a kernel component, an application program, a linked library, an object with methods, or other type of executable software code. The view maintenance engine 230 may be operably coupled to storage 232 that stores a catalog 234 of view 236 maintained by the view maintenance server 228. The storage 208 may be any type of computer storage media.

In an embodiment of a distributed database system for applying once a transaction delivered in a message published asynchronously in a distributed database, the distributed database system may be configured into clusters of servers with the data tables and indexes replicated in each cluster. In a clustered configuration, the database is partitioned across multiple servers so that different records are stored on different servers. Moreover, the database may be replicated so that an entire data table is copied to multiple clusters. This replication enhances both performance by having a nearby copy of the table to reduce latency for database clients and reliability by having multiple copies to provide fault tolerance.

To ensure consistency, the distributed database system may also feature a data mastering scheme. In an embodiment, one copy of the data may be designated as the master, and all updates are applied at the master before being replicated to other copies. In various embodiments, the granularity of mastership could be for a table, a partition of a table, or a record. For example, mastership of a partition of a table may be used when data is inserted or deleted, and once a record exists, record-level mastership may be used to synchronize updates to the record. The mastership scheme sequences all insert, update, and delete events on a record into a single, consistent history for the record. This history may be consistent for each replica.

Communication of updates between regions may be done through publishing messages to subscribers. The master region may publish record updates on an asynchronous channel to replicas that subscribe. Once an update is published to the messaging system, it will be delivered to all replicas. Thus, the messaging system is persistent. Once a message is written to the messaging system, that message is saved to survive machine failure and is guaranteed to be delivered to all regions. A message may be finally deleted once all subscribers have received it, acted on it, and explicitly allowed it to be deleted.

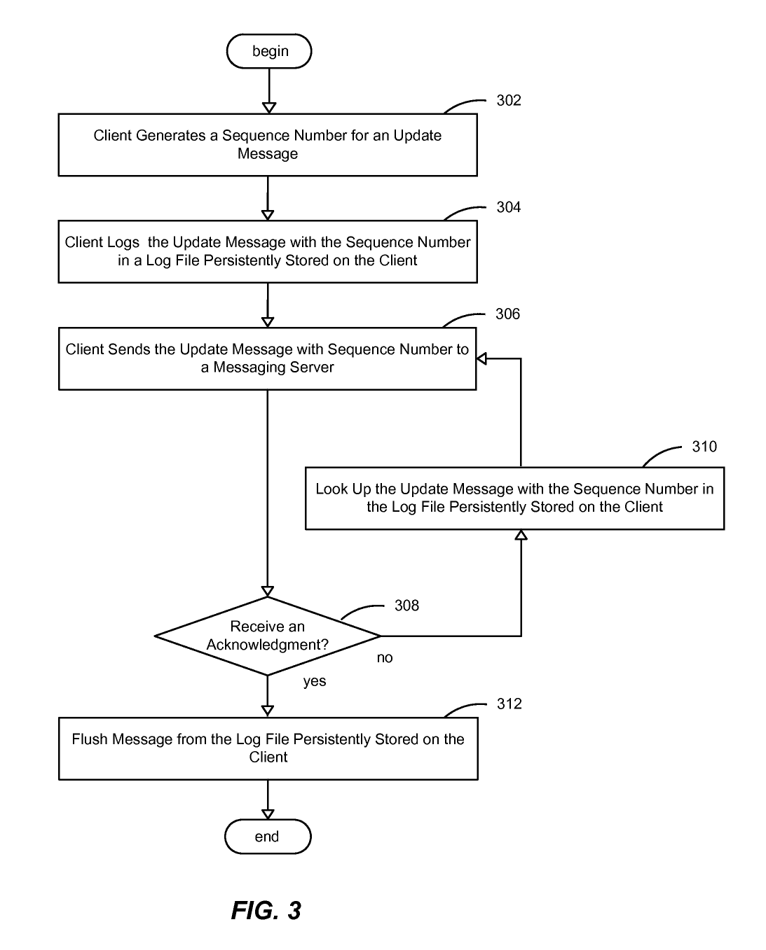

FIG. 3 presents a flowchart for generally representing the steps undertaken in one embodiment on a client for applying once a transaction delivered in a message published asynchronously in a distributed database. At step 302, a client may generate a sequence number for a transaction in a message to be published asynchronously in a distributed database. For example, an application may invoke a query interface for sending a request to update a data record in a distributed database, and a sequence number may be generated by the client for the transaction in the request. At step 304, the client may log the update message with the sequence number in a log file persistently stored on the client machine.

In general, the sequence number can be any globally unique value. For example, the IP address of the client concatenated with an increasing sequence number. By having a persistent log, the client may log pending attempted messages. And if a client repeats a message, it is published with the same unique sequence number. Similarly, if the client publishes a different message, but this new message represents a repeated transaction, the message is published with the same unique sequence number as in the original transaction. Thus, the publish may only succeed if there is no message tagged with a sequence number that has been previously published to the messaging machine. If the client re-attempts the publish with the first attempt having succeeded, for instance because the acknowledgement was lost, the subsequent publish attempt fails. Thus, the message may be applied once on a client for asynchronous publication.

At step 306, the client may send the update message with the sequence number to a messaging server for asynchronous publication in a distributed database. For instance, the update message may be sent to a server to be applied to a copy of the master data before being sent to other servers for replication to other copies of the data. The client may then determine at step 308 whether it received an acknowledgement from the messaging server. In an embodiment, a timer may be set to expire for a predetermined time period. Upon expiration of the timer, the client may then check whether an acknowledgement from the messaging server has been received.

If an acknowledgement from the messaging server has not been received by the client, then the client may look up the update message with the sequence number in the log file persistently stored on the client at step 310 and processing may continue at step 306 where the client may again send the update message with the sequence number to a messaging server for asynchronous publication. Otherwise, if the client determines that an acknowledgement from the messaging server has been received at step 308, then the client may flush the update message with the sequence number from the log file persistently stored on the client at step 312 and processing may be finished on the client for applying once a transaction delivered in a message published asynchronously in a distributed database.

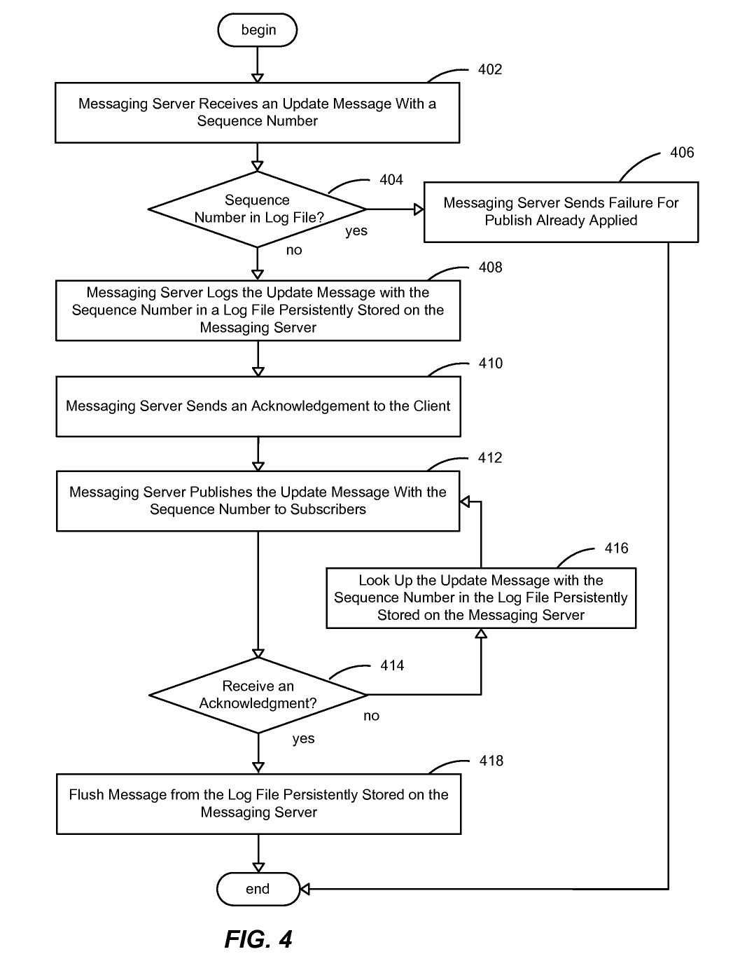

FIG. 4 presents a flowchart for generally representing the steps undertaken in one embodiment on a messaging server for applying once a transaction delivered in a message published asynchronously in a distributed database. At step 402, a messaging server may receive an update message with a sequence number for a transaction to be published asynchronously in a distributed database. For example, the messaging server may receive the message from a client requesting to update a data record in a distributed database, and a sequence number may be generated by the client for the transaction in the request. At step 404, the messaging server may check whether the sequence number appears in an update message in a log file persistently stored on the messaging server. If so, then the messaging server may send a failure response to the client at step 406 indicating that a publish request has been already applied for the sequence number. Otherwise, the messaging server may log the update message with the sequence number in a log file persistently stored on the messaging server at step 408. And at step 410, the messaging server may send an acknowledgement to the client computer that the update message is published.

At step 412, the messaging server may asynchronously publish the update message with the sequence number to subscribers. For instance, the update message may be sent to a server to be applied to a copy of the master data and then sent to other servers for replication to other copies of the data. The messaging server may then determine at step 414 whether it received an acknowledgement from the subscribers. In an embodiment, a timer may be set to expire for a predetermined time period. Upon expiration of the timer, the messaging server may then check whether an acknowledgement from the messaging server has been received.

If an acknowledgement from the subscribers has not been received by the messaging server, then the messaging server may look up the update message with the sequence number in the log file persistently stored on the messaging server at step 416 and processing may continue at step 412 where the messaging server may again send the update message with the sequence number to subscribers for asynchronous publication. Otherwise, if the messaging server determines that an acknowledgement has been received at step 414 from subscribers, then the messaging server may flush the update message with the sequence number from the log file persistently stored on the messaging server at step 416 and processing may be finished on the messaging server for applying once a transaction delivered in a message published asynchronously in a distributed database.

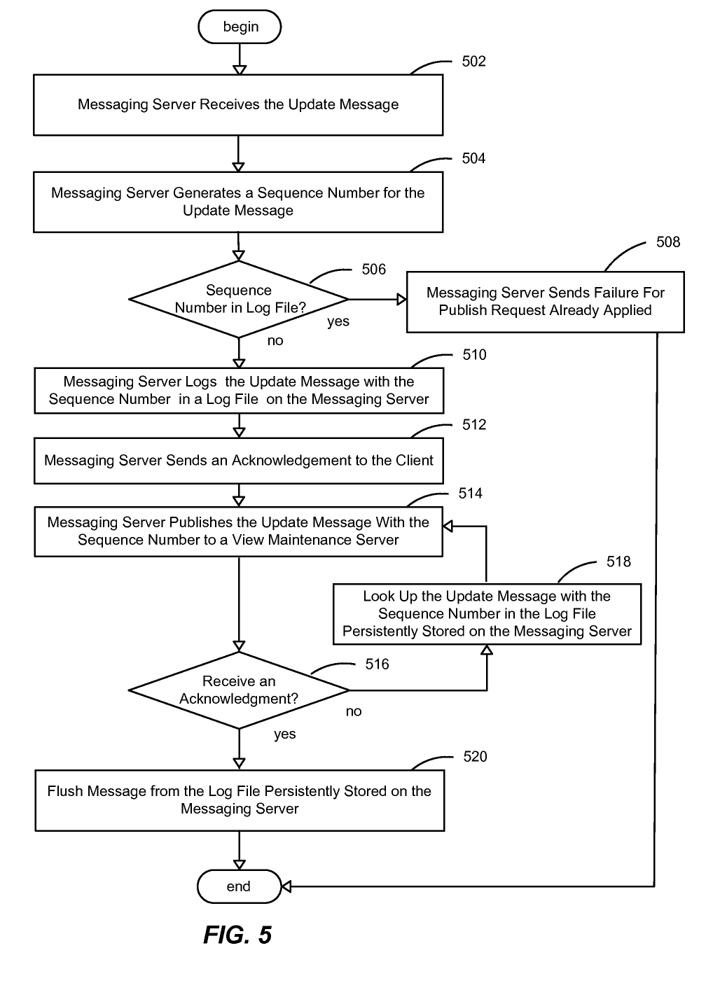

Alternatively, apply once messaging may also be achieved for asynchronous publication in various embodiments by having a persistent log stored on a messaging server. FIG. 5 presents a flowchart for generally representing the steps undertaken in one embodiment on a messaging server for applying once an update message by generating a sequence number for asynchronously publication in a distributed database. At step 502, a messaging server may receive an update message for a transaction to be published asynchronously in a distributed database. For example, the messaging server may receive the message from a client computer requesting to update a data record in the distributed database. At step 504, the messaging server may generate a sequence number for a transaction in the update message to be published asynchronously in a distributed database.

At step 506, the messaging server may check whether the sequence number appears in an update message in a log file persistently stored on the messaging server. If so, then the messaging server may send a failure response to the client computer at step 508 indicating that a publish request has been already applied for the sequence number. Otherwise, the messaging server may log the update message with the sequence number in a log file persistently stored on the messaging server at step 510. And at step 512, the messaging server may send an acknowledgement to the client computer that the update message is published.

At step 514, the messaging server may asynchronously publish the update message with the sequence number to subscribers. For instance, the update message may be sent to a server to be applied to a master copy of the data and then sent to other servers for replication to other copies of the data. The messaging server may then determine at step 516 whether it received an acknowledgement from the subscribers. In an embodiment, a timer may be set to expire for a predetermined time period. Upon expiration of the timer, the messaging server may then check whether an acknowledgement from the subscribers has been received.

If an acknowledgement from the subscribers has not been received by the messaging server, then the messaging server may look up the update message with the sequence number in the log file persistently stored on the messaging server at step 518 and processing may continue at step 514 where the messaging server may again send the update message with the sequence number to subscribers for asynchronous publication. Otherwise, if the messaging server determines that an acknowledgement has been received at step 516 from subscribers, then the messaging server may flush the update message with the sequence number from the log file persistently stored on the messaging server at step 520 and processing may be finished on the messaging server for applying once a transaction delivered in a message published asynchronously in a distributed database.

One of the subscribers for a message published asynchronously in a distributed database may be a view maintenance server responsible for listening to data updates and generating corresponding updates for data views. For instance, a common data view may be a group-by aggregate view. Consider for example a base table of user records, where each record lists the user's location (e.g. CA). A view table may maintain a count of the number of users in each state, where each record in the view table is a state and number of users with that location. When an update to the base table is published, that update, along with the value it is replacing, is provided to a view maintenance engine that produces corresponding view updates. Accordingly, if a user changes his location to CA, that, along with the previous location, such as NY, is provided to the view maintenance engine. The view maintenance engine may then decrement the NY count and increment the CA count. It may accomplish this by reading the NY count, for instance NY 32 100, and publishing an update NY=99, and reading the CA count, for instance CA=100, and publishing an update CA=101. This case requires apply once delivery. Without apply once delivery of the message, if the view maintenance engine fails and thus does not receive the update that CA=101 was successfully published and applied to the view table, when the view maintenance engine recovers, it may repeat the transaction, read CA 32 101, and publish CA=102.

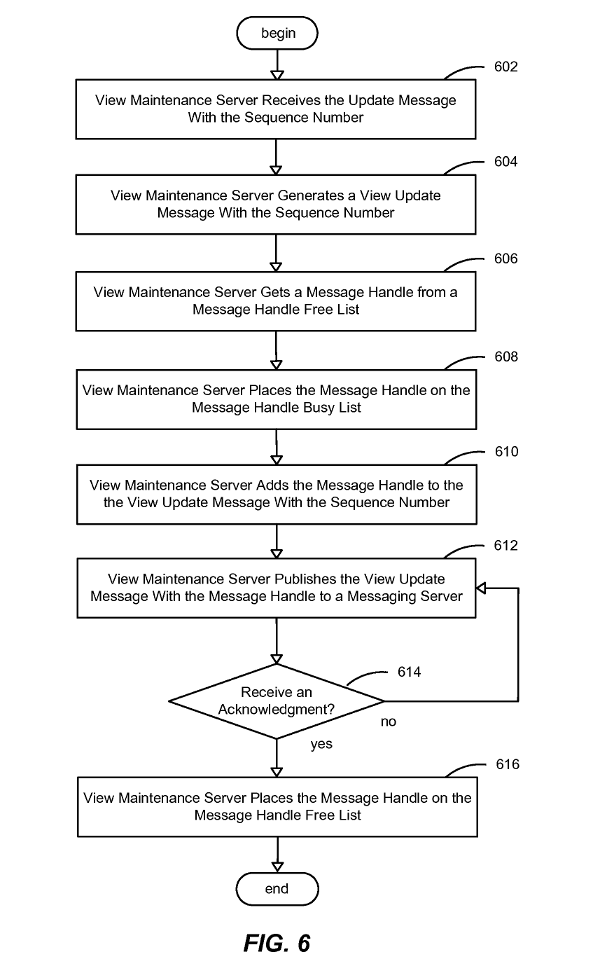

FIG. 6 presents a flowchart for generally representing the steps undertaken in one embodiment on a view maintenance server for applying once a transaction delivered in a message published asynchronously in a distributed database. At step 602, a view maintenance server may receive an update message with a sequence number from a messaging server publishing a transaction asynchronously in a distributed database. For example, the view maintenance server may be a subscriber for data update messages and receive an update message from a message server publishing a transaction asynchronously in a distributed database.

The view maintenance engine, or any publishing component, may have a set of handles that may be used to perform lazy garbage collection to purge messages from a messaging server's log file after receiving acknowledgement that the messages have been published. Each handle may represent a tag that is unique across all publishers. For instance, it may be some attribute that identifies the publisher concatenated with an auto-incremented number. The view maintenance engine may accordingly maintain two lists of handles: busy and free. In order to publish a message with a unique sequence number, the view maintenance engine must find a free handle, attach it to the unique sequence number, and move the handle to the busy list. Thus, a busy handle implies that a message is being published using it. Once the publish attempt to a messaging server with the unique sequence number is complete and acknowledged, and the original base update message acknowledged and consumed, and the view maintenance engine will not republish the message, view maintenance engine may move the handle back to the free list. And then the view maintenance engine may then use the handle on a future message for publication.

Returning to FIG. 6, the view maintenance server may generate a view update message with the sequence number at step 604 and may obtain a message handle from a message handle free list at step 606. The view maintenance server may then place the message handle on the message handle busy list at step 608, and the view maintenance server may add the message handle to the view update message with the sequence number at step 610.

At step 612, the view maintenance server may asynchronously publish the view update message with message handle and the sequence number to a message server. For instance, the view update message may be sent to a server to be applied to a copy of the master view data and then sent to other servers for replication to other copies of the view data. The view maintenance server may then determine at step 614 whether it received an acknowledgement from the messaging server. In an embodiment, a timer may be set to expire for a predetermined time period. Upon expiration of the timer, the view maintenance server may then check whether an acknowledgement from the messaging server has been received.

If an acknowledgement from the messaging server has not been received by the view maintenance server, then the view maintenance server may again send the update message with the message handle and sequence number to a messaging server for asynchronous publication at step 612. Otherwise, if the view maintenance server determines that an acknowledgement has been received at step 614 from a messaging server, then the view maintenance server may consider itself to have finished processing the original base update message and therefore can consume the base update message. Then the view maintenance server may place the message handle on the message handle free list for re-use at step 616 and processing may be finished on the view maintenance server for applying once a transaction delivered in a message published asynchronously in a distributed database.

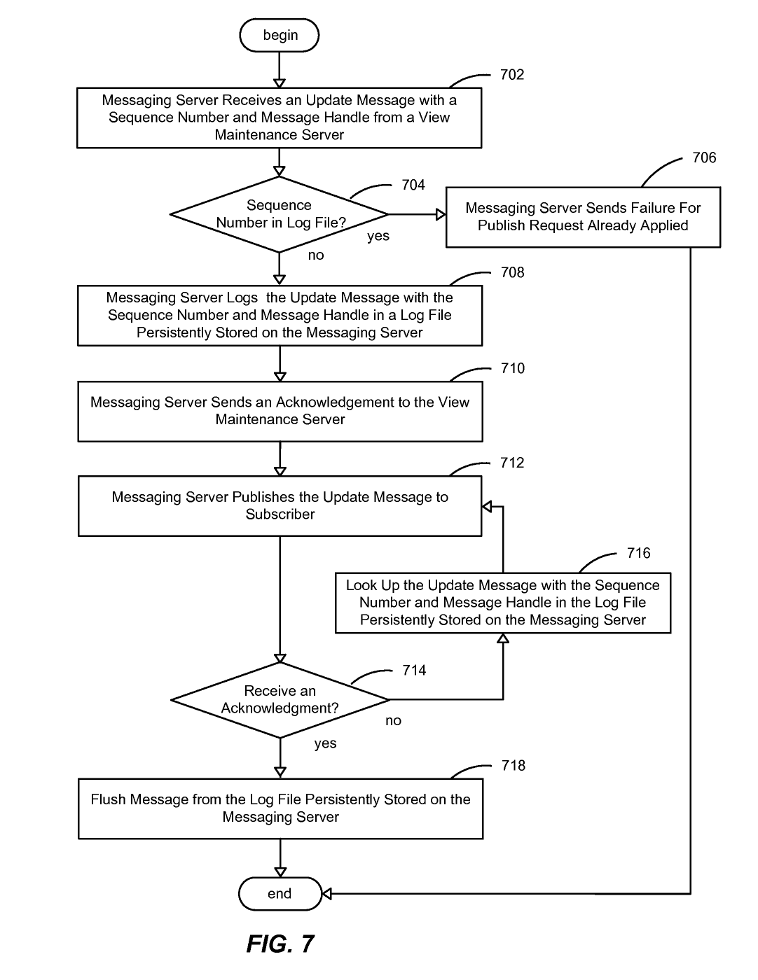

FIG. 7 presents a flowchart for generally representing the steps undertaken in one embodiment on a messaging server for applying once an update message with a sequence number and a message handle from a view maintenance server delivered for asynchronously publication in a distributed database. At step 702, a messaging server may receive an update message with a sequence number and a message handle from a view maintenance server for a transaction to be published asynchronously in a distributed database. For example, the messaging server may receive the message from a view maintenance server requesting to update a view record in a distributed database, and the message handle may be obtained and added to the update message by the view maintenance server for the transaction in the request. At step 704, the messaging server may check whether the sequence number appears in an update message in a log file persistently stored on the messaging server. If so, then the messaging server may send a failure response to the view maintenance server at step 706 indicating that a publish request has been already applied for the sequence number. Otherwise, the messaging server may log the update message with the sequence number and message handle in a log file persistently stored on the messaging server at step 708. And at step 710, the messaging server may send an acknowledgement to the view maintenance server that the update message is published.

At step 712, the messaging server may asynchronously publish the update message with the sequence number and message handle to subscribers. For instance, the update message may be sent to a server to be applied to a copy of the view data and then sent to other servers for replication to other copies of the view data. The messaging server may then determine at step 714 whether it received an acknowledgement from the subscribers. In an embodiment, a timer may be set to expire for a predetermined time period. Upon expiration of the timer, the messaging server may then check whether an acknowledgement from the subscribers has been received.

If an acknowledgement from the subscribers has not been received by the messaging server, then the messaging server may look up the update message with the sequence number in the log file persistently stored on the messaging server at step 716 and processing may continue at step 712 where the messaging server may again send the update message with the sequence number to subscribers for asynchronous publication. Otherwise, if the messaging server determines that an acknowledgement has been received at step 714 from subscribers, then the messaging server may flush the update message from the log file persistently stored on the messaging server at step 716 and processing may be finished on the messaging server for applying once a transaction delivered in a message published asynchronously in a distributed database.

Lazy garbage collection may be performed to purge a sequence number with a message handle from the log file of a messaging server when a message with a different sequence number re-uses a previously used handle. Once the publish attempt to a messaging server with a sequence number is acknowledged, and the initial base update has been consumed so it will not be re-delivered, the view maintenance server will move the handle from the message handle busy list back to the message handle free list. The view maintenance server may then re-use the message handle on another message sent to a messaging server for publication. When the messaging server receives a message tagged with the re-used message handle that occurs with some other sequence number, the messaging server may purge the previous sequence number with the message handle logged in the log file persistently stored on the messaging server.

In an embodiment, a log entry may not be flushed as soon as its handle re-appears with a different sequence number. Rather, new log entries of messages to be published may be written to the beginning of the log. A rolling purge process may repeatedly start at the top of the log, recording each handle it may find. If it detects a repeated use of a handle, it deletes the message entry from the log file. Additionally, very old entries may be deleted for the situation where a component generating handles may have died, and handles generated by it will never be re-used.

Applying once a transaction delivered in a message published asynchronously in a distributed database is useful in scenarios where different messages duplicating a single intent may be delivered. For instance, apply once also covers multiple different idempotent messages that refer to the same transaction. Moreover, the present invention may support a variety of scenarios for applying once a message, including, but not limited to, views, non-idempotent client operations such as incrementing/decrementing a field, and notification management, where some third-party wants one notification message each time a table is updated.

As can be seen from the foregoing detailed description, the present invention provides an improved system and method for applying once a transaction delivered in a message published asynchronously in a distributed database. In various embodiments, a messaging server may log an update message with a sequence number in a log file persistently stored on the messaging server, and the messaging server may send an acknowledgement that the update message is published. Then the messaging server may asynchronously publish the update message with the sequence number to subscribers. In the event the messaging server does not receive an acknowledgement from the subscribers, the messaging server may look up the update message with the sequence number in the log file persistently stored on the messaging server and may again send the update message with the sequence number to subscribers for asynchronous publication. The system and method may apply the update transaction exactly once, even if the transaction is repeated by having multiple publishes. As a result, the system and method provide significant advantages and benefits needed in contemporary computing, and more particularly in distributed database applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-implemented method for updating data tables, comprising:
generating by a client computer a sequence number for a message for publication of an update of a data record in a distributed database stored across a plurality of database servers;
logging by the client computer the message for publication of the update of the data record with the sequence number in a log file persistently stored on the client computer; and
sending by the client computer the message to a messaging server for publication of the update of the data record with the sequence number to at least one subscriber.

2. The system of claim 1 further comprising:
receiving an acknowledgment in response to publication of the update of the data record with the sequence number to at least one subscriber; and
flushing the message to publish the update of the data record with the sequence number in the log file persistently stored on the client computer.

3. A computer-readable medium having computer-executable instructions for performing the method of claim 1.

4. A computer-implemented method for updating data tables, comprising:
receiving a message to publish an update of a data record in a distributed database stored across a plurality of database servers;
verifying that a sequence number for the message to publish the update of the data record does not appear in a log file;
logging the message to publish the update of the data record with the sequence number in the log file; and
publishing the update of the data record with the sequence number to at least one subscriber.

5. The method of claim 4 further comprising sending an acknowledgement to a client to indicate publication of the message to update a data record in the distributed database.

6. The method of claim 4 further comprising generating a sequence number for the message to publish the update of the data record.

7. The method of claim 4 further comprising receiving an acknowledgment in response to publishing the update of the data record with the sequence number to at least one subscriber.

8. The method of claim 7 further comprising flushing the message to publish the update of the data record with the sequence number in the log file.

9. The method of claim 4 further comprising:
determining an acknowledgment is not received within a predetermined time period in response to publishing the update of the data record with the sequence number to at least one subscriber;
looking up the message to publish the update of the data record with the sequence number in the log file; and
publishing the update of the data record with the sequence number to the at least one subscriber.

10. A computer-readable medium having computer-executable instructions for performing the method of claim 4.

11. A computer-implemented method for updating data tables, comprising:
receiving by a messaging server a message to publish an update of a data record with a sequence number and a message handle in a distributed database stored across a plurality of database servers;
verifying by the messaging server that the sequence number for the message to publish the update of the data record does not appear in a log file;
logging by the messaging server the message to publish the update of the data record with the sequence number and message handle in the log file; and
publishing by the messaging server the update of the data record with the sequence number and message handle to at least one subscriber.

12. The method of claim 11 further comprising sending by the messaging server an acknowledgement to a view maintenance server to indicate publication of the message to update a data record in the distributed database.

13. The method of claim 11 further comprising receiving by a messaging server an acknowledgment in response to publishing the update of the data record with the sequence number to at least one subscriber.

14. The method of claim 11 further comprising flushing by the messaging server the message to publish the update of the data record with the sequence number in the log file persistently stored on the message server.

15. The method of claim 4 further comprising:
determining by the messaging server that an acknowledgment is not received within a predetermined time period in response to publishing the update of the data record with the sequence number and message handled to at least one subscriber;
looking up the message to publish the update of the data record with the sequence number and message handle in the log file; and
publishing by the messaging server the update of the data record with the sequence number and message handle to the at least one subscriber.

16. The method of claim 11 further comprising receiving by a view maintenance server the message to publish the update of the data record with the sequence number.

17. The method of claim 11 further comprising:
generating by a view maintenance server a message of a view update for the data record with the sequence number;
obtaining by the view maintenance server the message handle from a message handle free list;
placing by the view maintenance server the message handle on a message handle busy list; and
adding by the view maintenance server the message handle to the message of the view update of the data record with the sequence number.

18. The method of claim 11 further comprising sending by a view maintenance server a message to the messaging server for publication of a view update of the data record with a sequence number and a message handle.

19. The method of claim 18 further comprising placing by the view maintenance server the message handle on the message handle free list.

20. A computer-readable medium having computer-executable instructions for performing the method of claim 11.
